(19) United States
(12) Patent Application Publication
(10) Pub. No.: US 2025/0147675 A1
(43) Pub. Date: May 8, 2025

(54) METHOD FOR STORING CRITICAL DATA

(71) Applicant: STMicroelectronics International N.V., Geneva (CH)

(72) Inventor: Mark TRIMMER, Coublevie (FR)

(21) Appl. No.: 18/939,624

(22) Filed: Nov. 7, 2024

(30) Foreign Application Priority Data
Nov. 8, 2023 (FR) 2312138

(51) Int. Cl. G06F 3/06; H04L 9/06; H04L 9/08

(52) U.S. Cl. CPC G06F 3/0622; G06F 3/0655; G06F 3/0673; H04L 9/0631; H04L 9/088

(57) ABSTRACT

The present disclosure provides a method and electrical device for storing blocks of critical data of the electrical device in a memory that is external to the electrical device. An example method includes: obtaining first encrypted blocks of data by encrypting blocks of critical data using a first encryption key; obtaining second encrypted blocks of data by encrypting blocks of critical data using a second encryption key different from the first encryption key; and storing first and second encrypted blocks of data in the memory.

### CROSS REFERENCE TO RELATED APPLICATION(S)

This application claims the priority benefit of French patent application number FR2312138, filed on Nov. 8, 2023, entitled “Method for storing critical data”, which is hereby incorporated by reference to the maximum extent allowable by law.

### TECHNICAL FIELD

The present disclosure relates generally to electrical circuits and devices, and more particularly the security of critical data used in such circuits and devices. The present disclosure concerns more precisely a method for storing critical data in an external memory.

### BACKGROUND

Storing critical data in an electrical device is a task that is part of the general security management of the electrical device.

It would be desirable to at least partly improve certain aspects of known method for storing critical data in an external memory.

### BRIEF SUMMARY

There is a need for a method for storing critical data that is more secure.

There is a need for a method for storing critical data in an external memory that is more secure.

There is a need for a method for storing critical data that does not add complexity to the method.

There is a need for a method for storing critical data that can detect a modification of the critical data immediately.

There is a need for an electrical device capable of executing the previously described method for storing critical data.

One embodiment addresses all or some of the drawbacks of known method for storing critical data.

One embodiment provides a method for storing blocks of critical data of an electrical device in a memory that is external to the electrical device, comprising the following steps:
Obtaining first encrypted blocks of data by encrypting blocks of critical data using a first encryption key;
Obtaining second encrypted blocks of data by encrypting blocks of critical data using a second encryption key different from the first encryption key; and
Storing first and second encrypted blocks of data in the memory.

Another embodiment provides an electrical device configured to store blocks of critical data in a memory that is external to the electrical device by executing the following steps:
Obtaining first encrypted blocks of data by encrypting blocks of critical data using a first encryption key;
Obtaining second encrypted blocks of data by encrypting blocks of critical data using a second encryption key different from the first encryption key; and
Storing first and second encrypted blocks of data in the memory.

According to an embodiment, the first and second encrypted blocks of data are mixed into the memory.

According to an embodiment, in the memory, each data composing the each first encrypted block of data is stored immediately before the corresponding second encrypted block of data.

According to an embodiment, the first and second encrypted blocks of data are obtained by applying AES to the critical data.

According to an embodiment, the first encrypted blocks of data are obtained by using the following steps:
(a) Combining blocks of critical data with a first word of data; and
(b) Encrypting the result of step (a) with the first encryption key.

According to an embodiment, the second encrypted blocks of data are obtained by using the following steps:
(c) Combining blocks of critical data with the first encrypted blocks of data; and
(d) Encrypting the result of step (c) with the second encryption key.

According to an embodiment, the memory is a DRAM memory.

According to an embodiment, the electrical device comprises a processor capable of processing critical blocks of data.

Another embodiment provides a method for retrieving critical blocks of data stored in a memory by using the previously described method.

Another embodiment provides a device being able to retrieve critical blocks of data stored in a memory by using the previously described method.

According to an embodiment, the method comprises the following steps:
Get first and second encrypted blocks of data from the memory;
Decrypt first encrypted blocks of data using the first encryption key;
Decrypt second encrypted blocks of data using the second encryption key; and
Compare the results of both decryption steps, if they are identical the blocks of critical data can be used.

According to an embodiment, if the result of both decryption steps are not identical, the blocks of critical data cannot be used.

According to an embodiment, the step of getting first and second encrypted blocks of data from the memory comprises a step of separating first and second encrypted data.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates, very schematically and in block forms, an example of electronic device capable of executing the embodiment described in relation with FIGS. 2 to 4;

FIG. 2 illustrates, schematically and in block forms, a first embodiment of a method for storing critical data;

FIG. 3 illustrates, in block forms, a step of the embodiment of FIG. 2;

FIG. 4 illustrates, schematically and in block forms, an example of the execution of the first embodiment of FIG. 2; and

FIG. 5 illustrates, schematically and in block forms, a second embodiment of a method for storing critical data.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

The embodiments described hereafter concern the storing of critical data in memory, and the corresponding retrieving method. In the following, critical data are data of which the access to is restricted to one or a plurality of specific persons and/or devices. In most cases, when a processor or a circuit is processing sensible data, such data are stored in a memory that is trusted by the processor or circuit. It is more convenient for security purposes.

A trusted memory is often a memory that is mounted on a same die as the processor or circuit, and with whom a secure communication is possible. Due to space restrictions in electronic device, it is common that a trusted memory does not have enough storing capacity to process all the necessary critical data. For that purpose, it is more convenient to use an untrusted memory to store critical data. An untrusted memory, called hereafter an external memory, is a memory with whom a secure communication is not possible. For that matter, an untrusted memory is often not mounted on the same die as the processor or circuit.

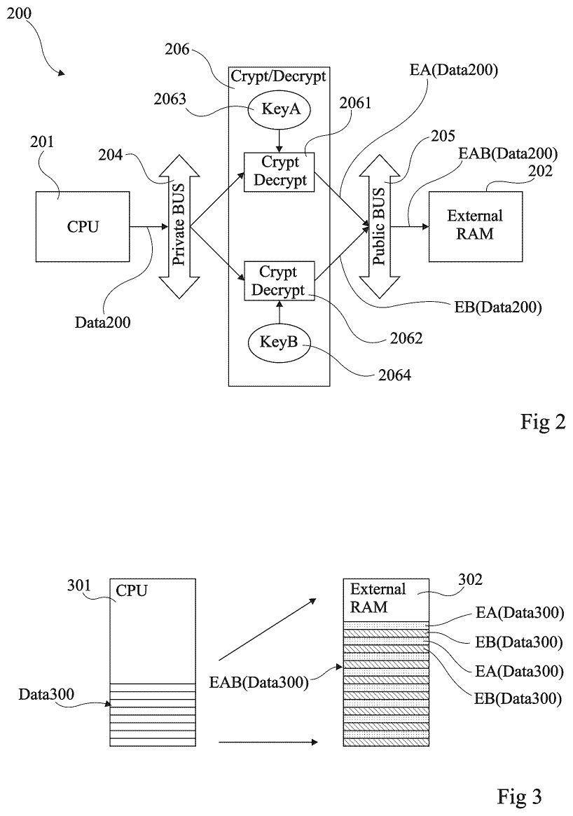

If critical data are stored in an untrusted memory, a way of securing the critical data needs nevertheless to be executed. The embodiments described hereafter concerns a secure method for storing of critical data in an untrusted memory, and the corresponding retrieving method. For that matter, the method comprises a double encryption steps with different encryption keys and a step of mixing encrypted data. This will prevent data to be accessible to and/or modified by an unauthorized person or circuit. Such methods are described in more details in relation with FIGS. 2 to 4.

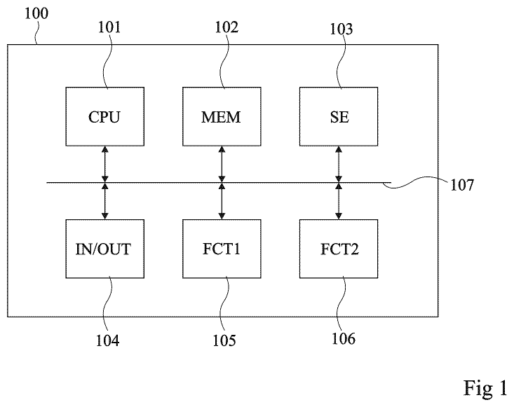

FIG. 1 shows, very schematically and in block form, an electronic device 100 capable of implementing the method for storing critical data described in relation with FIGS. 2 to 4.

Device 100 is an electronic device configured to processing data, and more particularly, to processing critical data.

Device 100 comprises a processor 101 (CPU) enabled to process data. According to an example, device 100 may comprise a plurality of processors, each configured for processing different types of data. According to a specific example, device 100 may comprise at least one processor that is configured to process critical data.

Device 100 further comprises one or a plurality of memories 102 (MEM) into which are stored data, for example, critical data. According to an example, device 100 comprises a plurality of types of memories, such as a ROM, a RAM a volatile memory, and/or a non-volatile memory. According to a specific example, device 100 may comprise one or more memories that are trusted by the processor 101 and that have a secure access to the processor 101. According to an embodiment, device 100 comprises one or more external memories, or untrusted memories, that do not have a secure access to the processor 101. The method for storing critical data described in relation with FIGS. 2 to 4 concerns the storing of critical data by the processor 101 in an external memory.

Device 100 further comprises one or more secure element 103 (SE) configured to processing critical and/or secret data. Secure element 103 may comprise its own processor(s), its own memory or memories, etc. According to an example, the method for storing critical data described in relation with FIGS. 2 to 4 may concern the storing of critical data by the secure element 103 in an external memory.

Device 100 further and optionally comprises one or a plurality of input/output circuits 104 (I/O) enabling device 100 to transmit and/or to receive data and/or energy with one or a plurality of external electronic devices.

Device 100 further comprises one or a plurality of circuits 105 (FCT1) and 106 (FCT2) implementing one or a plurality of functionalities of device 100. According to an example, circuits 105 and 106 may comprise specific data processing circuits, such as ciphering circuits, or circuits enabling to perform measurements, such as sensors.

Device 100 further comprises one or a plurality of communication buses 107 enabling all the circuits of device 100 to communicate. In FIG. 1, a single bus 107 coupling processor 101, memory or memories 102, secure element 103, and circuits 104 to 106 is shown but in practice, device 100 comprises a plurality of communication buses coupling these different elements.

FIG. 2 represents, in block form, the execution, by a device 200, of an embodiment of a method for storing critical data in a memory.

According to an embodiment, device 200 comprises a processor 201 (CPU) of the type of processor 101 described in relation with FIG. 1, and a memory 202 (External RAM) that is considered untrusted by the processor 201. Memory 202 is, hereafter, called an external memory. Processor 201 is capable of processing critical data, and needs to store critical data into memory 202.

Processor 201 has access to a private bus 204 (PRIVATE BUS) ensuring secure communication with other circuit or component of device 200.

Memory 202 has only access to a public bus 205 (Public BUS) to communicate with other components of device 200, and especially with processor 201. According to an example, the memory 202 is a Random Access Memory, also called RAM, and more particularly, a Dynamical Random Access memory, also called DRAM.

Device 201 further comprises an encryption and decryption unit 206 (Crypt/Decrypt) configured to connect both buses 204 and 205. More particularly, unit 206 is capable of exchanging critical data with the private bus 204, and of exchanging encrypted data with the public bus 205.

According to an embodiment, unit 206 comprises two identical encryption and decryption engines 2061 and 2062 capable of:
encrypting critical data received from the private bus 204; and
decrypting encrypted data received from the public bus 204.

The only difference between engines 2061 and 2062 is that they are working with different encryption and decryption keys 2063 (KeyA) and 2064 (KeyB). In FIG. 2, engine 2061 is using the encryption and decryption key 2063, engine 2062 is using the encryption and decryption key 2064.

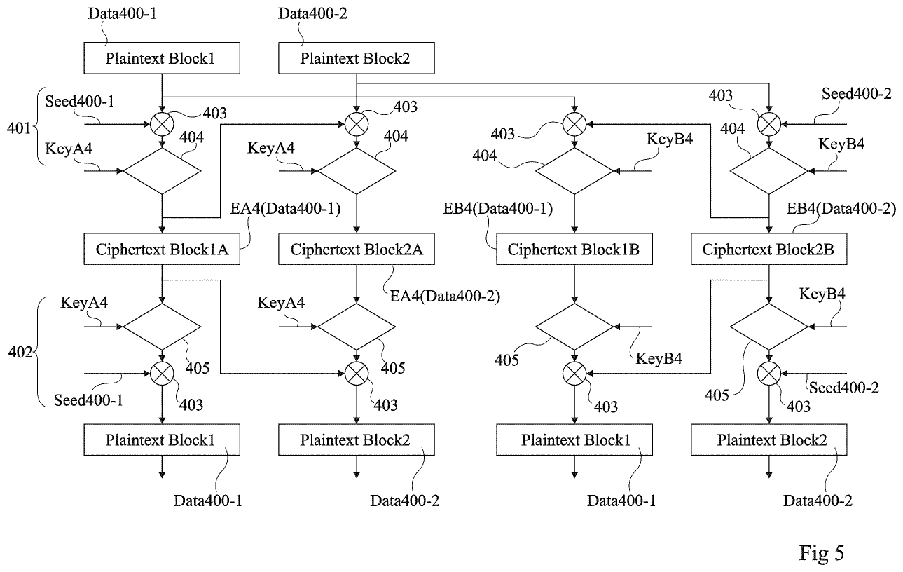

For that purpose, engines 2061 and 2062 can implement different types of symmetrical encryption and decryption algorithms. One example of an encrypting and decrypting algorithm that can be used is the Advanced Encryption Standard, also called AES. This specific example is described in detail in relation with FIG. 5.

A method for storing critical data of processor 201 into the external memory 202 is the following. Some critical data of processor 201 is considered here. This critical data is divided in blocks of critical data Data200 of same sizes. Blocks of critical data Data200 are send to the encryption and decryption unit 206, via the private bus 204. Then, unit 206 uses both engines 2061 and 2062 to encrypt each block of critical data Data200. More particularly, engine 2061 encrypt each block of critical data Data200, using the encryption and decryption key 2063, in order to provide a first encrypted block of data EA (Data200). At the same time, engine 2062 encrypt each block of critical data Data200, using the encryption and decryption key 2064, in order to provide a second encrypted block of data EB (Data200).

Both first and second encrypted blocks of data EA (Data200) and EB (Data200) are send to the memory 202 for storing, via the public bus 205. According to a preferred embodiments, the first and second encrypted blocks of data EA (Data200) and EB (Data200) are mixed in the memory 202. A preferred way of mixing first and second encrypted blocks of data EA (Data200) and EB (Data200) in memory 202 is described in details in relation with FIG. 3.

Thus, a method for storing blocks of critical data Data200 in the external memory 202 comprises the following steps:
Encrypting each block of critical data Data200 with a first encryption and decryption key 2063 to obtain a first encrypted block of data EA (Data200);
Encrypting each block of critical data Data200 with a second encryption and decryption key 2064 to obtain a second encrypted block of data EB (Data200); and
Storing each first and second encrypted block of data EA (Data200) and EB (Data200) in the external memory 202, and, for example, mixing the first and second encrypted blocks of data EA (Data200) and EB (Data200).

Once first and second encrypted blocks of data EA (Data200) and EB (Data200) are stored in the memory, a method for retrieving the critical data is the following. Both first and second encrypted blocks of data EA (Data200) and EB (Data200) are retrieved from the external memory 202.

The first and second encrypted blocks of data EA (Data200) and EB (Data200) are send to the encryption and decryption unit 206, via the public bus 205. Each encrypted block of data is decrypted by an engine 2061 or 2062. More particularly, first encrypted block of data EA (Data200) are decrypted using engines 2061 and key 2063, since key 2063 was used to obtain encrypted block of data EA (Data200). Second encrypted block of data EB (Data200) are decrypted using engines 2062 and key 2064, since key 2064 was used to obtain encrypted blocks of data EB (Data200). Both decrypted blocks of data are then compared. If they are identical, the correct blocks of critical data Data200 have been retrieved and can be send to the processor 201, via private bus 204. If they are not identical, the correct blocks of critical data Data200 have not been retrieved, because it has been corrupted. The processor cannot use the decrypted blocks of data.

Thus, a method for retrieving blocks of critical data Data200 that have be stored in the external memory 202 using the previous method comprises the following steps:
Get first and second encrypted blocks of data EA (Data200) and EB (Data200) from external memory 202;
Decrypt first encrypted blocks of data EA (Data200) using the first encryption key 2063;
Decrypt second encrypted blocks of data EB (Data200) using the second encryption key 2064; and
Compare the results of both decryption steps, if they are identical the blocks of critical data can be used by the processor.

One advantage to these methods is to allow a processor to store critical data into an untrusted memory.

FIG. 3 represents, in block form, a mixing step of the encrypted data of the embodiment of FIG. 2.

In FIG. 3 are represented some critical blocks of data Data300 as they are before storing in an external memory, that is in a processor 301 (CPU).

In FIG. 3 are also represented the first and second encrypted blocks of data EA (Data300) and EB (Data300) resulting from the storing method described in relation with FIG. 2. Both first and second encrypted blocks of data EA (Data300) and EB (Data300) are stored in an external memory 302 (External RAM).

According to an embodiment, first and second encrypted blocks of data EA (Data300) and EB (Data300) are mixed in memory 302. In other words, the entire two versions of encrypted data are not written in one block in memory 302, but are separated in several blocks of data written is different part of the memory.

According to a preferred embodiment, each first encrypted blocks of data EA (Data300) is stored between two second encrypted blocks of data EB (Data300). Similarly, each second encrypted blocks of data EB (Data300) is stored between two first encrypted blocks of data EA (Data300). In other words, each first encrypted blocks of data EA (Data300) is stored immediately before the corresponding second encrypted blocks of data EB (Data300). Similarly, each second encrypted blocks of data EB (Data300) is stored immediately before the corresponding first encrypted blocks of data EA (Data300).

Thus, if someone wants to corrupt the critical blocks of data Data300 by accessing memory 302, it is most likely that two different parts of the first and second encrypted blocks of data are being corrupted. Then, it is extremely unlikely that the two corrupted blocks of data will decrypt to identical results. There is concept of “diffusion” in encryption algorithms, whereby if just 1 bit of the encrypted data is changed, then that will be relevant to all the bits of the decrypted block (not just nearby bits), and change about half of them, on average.

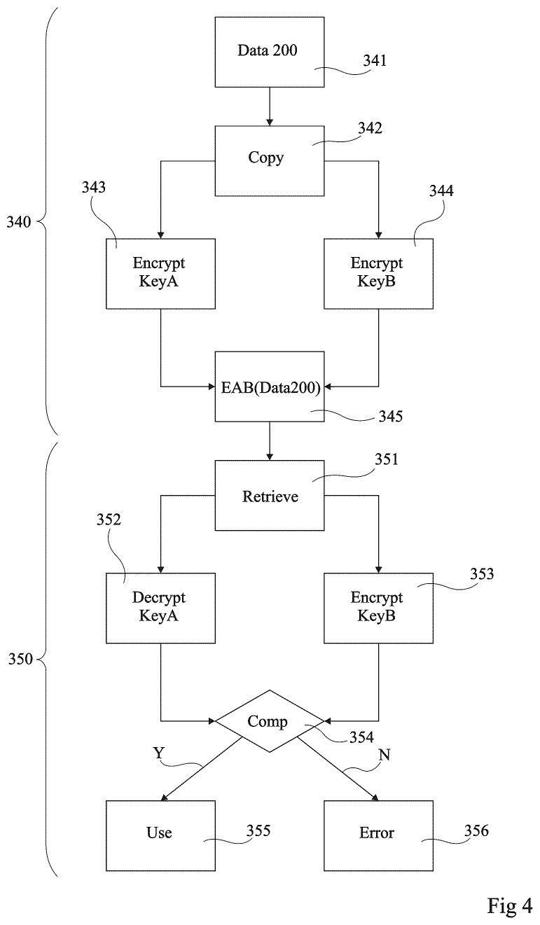

FIG. 4 represents, in block form, an example of the execution of the embodiment of the methods described in relation with FIG. 2.

More particularly, FIG. 4 represents a method 340 for storing critical data in a memory according to the embodiment described in relation with FIG. 2, and a method 350 for retrieving such critical data in the memory according to the embodiments described in relation with FIG. 2.

Thus, method 340 comprises the following steps.

At an initial step 341 (Data200), processor 201 of FIG. 2 wants to store some blocks of critical data Data200 into the external memory 202.

At a step 342 (Copy), following step 341, processor 201 creates a copy of blocks of critical data Data200 and send both copies to the encryption and decryption unit 206 via the private bus 204.

At a step 343 (Encrypt KeyA), following step 342, engine 2061 of encryption and decryption unit 206 encrypts the first copy of blocks of critical data Data200 using first encryption and decryption key 2063. A first encrypted data EA (Data200) is generated.

At a step 344 (Encrypt KeyB), following step 342, engine 2062 of encryption and decryption unit 206 encrypts the second copy of blocks of critical data Data200 using second encryption and decryption key 2064. A second encrypted data EB (Data200) is generated.

At a step 345 (EAB (Data200)), following steps 343 and 344, both first and second encrypted blocks of data EA (Data200) and EB (Data200) are send to the memory 202 for storing, via the public bus 205. According to the preferred embodiments, the first and second encrypted blocks of data EA (Data200) and EB (Data200) are mixed in the memory 202, for example using the way of mixing described in details in relation with FIG. 3.

Method 350 comprises the following steps.

At an initial step 351 (Retrieve), data EAB (Data200) is retrieved as first and second encrypted blocks of data EA (Data200) and EB (Data200) from the memory 202.

At a step 352 (Decrypt KeyA), following step 351, each first encrypted block of data EA (Data200) is then decrypted by using the encryption and decryption key 2063 to obtain a first copy of a block of data Data200.

At a step 353 (Decrypt KeyB), following step 351, each second encrypted block of data EB (Data200) is then decrypted by using the encryption and decryption key 2064 to obtain a second copy of a block of data Data200.

At a step 354 (Comp), following steps 352 and 352, both copies of each block of critical data Data200 are compared. If the comparison is a success (output Y of bloc 354), next step is step 355 (Use). Otherwise (output N of bloc 354), next step is step 356 (Error).

At step 355 (Use), each copies of blocks of critical data Data200 are identical, it means that data EAB (Data200) has not been corrupted during its storage in memory 202. Processor 201 can use safely critical data Data200.

At step 356 (Error), At least one copy of a block of critical data Data200 are not identical, it means that data EAB (Data200) has been corrupted during its storage in memory 202. According to an example, an error message may be sent to processor 201. According to another example, both copies of blocks of critical data Data200 can be sent to processor for analysis.

FIG. 5 represents, in block form, the execution of a variant of the embodiment of the methods described in relation with FIG. 2.

More particularly, FIG. 5 represents the execution of a method 401 for storing critical data in an external memory, and a method 402 for retrieving the data. According to an embodiment, both methods 401 and 402 are using the AES algorithm to encrypt and decrypt data. More particularly, both methods 401 and 402 are using the chaining of several AES operations, usually called AES-CBC for AES-Cipher-Block-Chaining.

The method 401 for storing critical data in an external memory is the following. The critical data are sent by a processor of the type of processor 201 of FIG. 2 to an encryption and decryption unit of the encryption and decryption unit 206 of FIG. 2. The unit creates two copies of blocks of the critical data, referenced hereafter as Data400-1 (Plaintext Block1) and Data400-2 (Plaintext Block2).

The first copy Data400-1 is combined with a first word of data Seed400-1 using an EXCLUSIVE OR logical operation 403, also called XOR operation, and then an encryption operation 404 is used, with an encryption key KeyA4, to obtain a first encrypted copy Data EA4 (Data400-1) (Ciphertext Black 1A). According to an example, the encryption operation 404 is an implementation of an AES encryption operation. Then, the second copy Data400-2 is combine with the first encrypted copy Data EA4 (Data400-1), using XOR operation 403, and then the encryption operation 404 is used, with the encryption key KeyA4, to obtain a second encrypted copy Data EA4 (Data400-2) (Ciphertext Black 2A). Thus, two different encrypted data are obtained.

Parallelly, the second copy Data400-2 is also combine with a second word of data Seed400-2, using XOR operation 403, and then the encryption operation 404 is used, with another encryption key KeyB4, to obtain a second encrypted copy Data EB4 (Data400-2) (Ciphertext Black 1B). Then, the first copy Data400-1 is also combine with the second encrypted copy Data EB4 (Data400-2) using XOR operation 403, and the encryption operation 404 is used, with the encryption key KeyB4, to obtain a first encrypted copy Data EB4 (Data400-1) (Ciphertext Black 2B). Thus, two different encrypted blocks of data are obtained once again.

All encrypted blocks of data EA4 (Data400-1), EA4 (Data400-2), EB4 (Data400-1), and EB4 (Data400-2) can be stored in the memory. According to a preferred variant, all encrypted data EA4 (Data400-1), EA4 (Data400-2), EB4 (Data400-1), and EB4 (Data400-2) can be mixed and stored in the memory, as described in relation with FIG. 3.

The method 402 for retrieving the critical blocks of data is the following. All encrypted blocks of data EA4 (Data400-1), EA4 (Data400-2), EB4 (Data400-1), and EB4 (Data400-2) are retrieved from memory.

Each encrypted block of data EA4 (Data400-1) is decrypted by using a decryption operation 405, and the key KeyA4, and then separated from the word of data Seed400-1 by using the XOR operation 403. According to an example, the encryption operation 404 is an implementation of an AES decryption operation. Each encrypted block of data EA4 (Data400-2) is decrypted by using the decryption operation 405, and then separated from the encrypted block of data EA4 (Data400-1) by using the XOR operation 403. The copy Data400-1 should then be retrieved as a results of both operations.

Similarly, each encrypted block of data EB4 (Data400-2) is decrypted by using a decryption operation 405, and the key KeyB4, and then separated from the word of data Seed400-2 by using the XOR operation 403. Each encrypted block of data EB4 (Data400-1) is decrypted by using the decryption operation 405, and then separated from the encrypted block of data EB4 (Data400-2) by using the XOR operation 403. The copy Data400-2 should then be retrieved as a results of both operations.

According to a preferred embodiment, method 401 uses an encryption key of 256 bits and uses it to encrypt data blocks of 128 bits. It has to be noted that random corruptions in both of the two 128-bit ciphered blocks in the memory have a 1 in 2128 chance of resulting in identical decrypted plaintexts. This means that, the security strength against collision resistance is 128-bit. In order to achieve 256-bit collision resistance, we must use Cipher-Block-Chaining (CBC) method to link two 128-bit blocks together, and this is why the XOR operation 403 are performed with data EA4 (Data400-1) and Data400-2, and with data EA4 (Data400-2) and Data400-1. According to an example, if the XOR operation 403 is performed with data EA4 (Data400-2) and Data400-1, and with data EB4 (Data400-1) and Data400-2, in case of an attack, data Data400-2 may be corrupted by the chaining and so the method will only have a 128-bit collision resistance.

Comparison steps of each bloc of data are then performed to determinate is the decrypted blocks of data are all identical. The advantage of the use of AES-CBC algorithm is to ensure that an attacker cannot just look for two encrypted blocks that happen to decrypt to identical values via the two keys. They have to look for two pairs of encrypted blocks that happen to decrypt to two identical pairs of values. This doubles the resistance against brute force attacks.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. A method for storing blocks of critical data of an electrical device in a memory that is external to the electrical device comprising:
obtaining first encrypted blocks of data by encrypting the blocks of critical data using a first encryption key;
obtaining second encrypted blocks of data by encrypting the blocks of critical data using a second encryption key different from the first encryption key; and
storing the first encrypted blocks of data and the second encrypted blocks of data in the memory.

2. The method of claim 1, wherein the first encrypted blocks of data and the second encrypted blocks of data are mixed into the memory.

3. The method of claim 1, wherein, in the memory, each data composing the each first encrypted block of data is stored immediately before the corresponding second encrypted block of data.

4. The method of claim 1, wherein the first encrypted blocks of data and the second encrypted blocks of data are obtained by applying AES to the blocks of critical data.

5. The method of claim 4, wherein a first copy of first encrypted blocks of data is obtained by:
(a) combining first blocks of critical data with a first word of data;
(b) encrypting the result of step (a) with the first encryption key;
wherein a first copy of the second encrypted blocks of data is obtained by:
(a′) combining second blocks of critical data with the first copy of the first encrypted blocks of data; and
(b′) encrypting the result of step (a′) with the first encryption key.

6. The method of claim 4, wherein a second copy of second encrypted blocks of data is obtained by:
(c) combining second blocks of critical data with the first encrypted blocks of data;
(d) encrypting the result of step (c) with the second encryption key;
wherein a second copy of first encrypted blocks of data is obtained by:
(c′) combining first blocks of critical data with the second copy of the second encrypted blocks of data; and
(d′) encrypting the result of step (c′) with the second encryption key.

7. The method of claim 1, wherein the memory is a DRAM memory.

8. The method of claim 1, wherein the electrical device comprises a processor configured for processing the critical blocks of data.

9. A method for retrieving the critical blocks of data stored in the memory by using the method of claim 1.

10. A device configured to retrieve the critical blocks of data stored in the memory by using the method of claim 1.

11. The method of claim 9 further comprising:
getting the first encrypted blocks of data and the second encrypted blocks of data from the memory;
decrypting the first encrypted blocks of data using the first encryption key;
decrypting the second encrypted blocks of data using the second encryption key; and
comparing the results of both decrypting steps, if the results are identical then the blocks of critical data can be used.

12. The method of claim 9, wherein, if the result of both decryption steps are not identical, the blocks of critical data cannot be used.

13. The method of claim 9, wherein the step of getting the first encrypted blocks of data and the second encrypted blocks of data from the memory comprises separating the first encrypted data and the second encrypted data.

14. An electrical device configured to store blocks of critical data in a memory that is external to the electrical device by executing the following steps:
obtaining first encrypted blocks of data by encrypting the blocks of critical data using a first encryption key;
obtaining second encrypted blocks of data by encrypting the blocks of critical data using a second encryption key different from the first encryption key; and
storing first and second encrypted blocks of data in the memory.

15. The electrical device of claim 14, wherein the first encrypted blocks of data and the second encrypted blocks of data are mixed into the memory.

16. The electrical device of claim 14, wherein, in the memory, each data composing the each first encrypted block of data is stored immediately before the corresponding second encrypted block of data.

17. The electrical device of claim 14, wherein the first encrypted blocks of data and the second encrypted blocks of data are obtained by applying AES to the blocks of critical data.

18. The electrical device of claim 17, wherein the electrical device is configured to obtain a first copy of first encrypted blocks of data by:
(a) combining first blocks of critical data with a first word of data;
(b) encrypting the result of step (a) with the first encryption key;
wherein the electrical device is further configured to obtain a first copy of the second encrypted blocks of data by:
(a′) combining second blocks of critical data with the first copy of the first encrypted blocks of data; and
(b′) encrypting the result of step (a′) with the first encryption key.

19. The electrical device of claim 17, wherein the electrical device is configured to obtain a second copy of second encrypted blocks of data by:
(c) combining second blocks of critical data with the first encrypted blocks of data;
(d) encrypting the result of step (c) with the second encryption key;
wherein the electrical device is further configured to obtain a second copy of first encrypted blocks of data by:
(c′) combining first blocks of critical data with the second copy of the second encrypted blocks of data; and
(d′) encrypting the result of step (c′) with the second encryption key.

20. The electrical device of claim 17, wherein the memory is a DRAM memory.
